(19) United States
(12) Patent Application Publication
(10) Pub. No.: US 2003/0163371 A1
(43) Pub. Date: Aug. 28, 2003

(54) System and method for presenting information over time to a user

(76) Inventor: Jeremy Beard, Western Australia (AU)

Correspondence Address: HARNESS, DICKEY & PIERCE, P.L.C., P.O. BOX 8910, RESTON, VA, 20195, US

(21) Appl. No.: 10/257,450

(22) PCT Filed: Apr. 11, 2001
(86) PCT No.: PCT/AU01/00412

(51) Int. Cl. G06F 17/60

(52) U.S. Cl. 705/14

(57) ABSTRACT

A system and method for presenting information over time to a user over a computer network (12), in which a server (14) stores presentation information (22) and control information (24). The user's computer (10) is responsive to the presentation information (22) and the control information (24), to produce a presentation which includes at least one prompt to the user at at least one randomly determined point during the presentation and to deliver the presentation to the user. The computer (10) also communicates to the server (14) whether the user provided a desired response within a predefined period during and/or after each prompt, following which the server (14) credits the user with having watched the information.

### FIELD OF THE INVENTION

This invention relates to a method and system for presenting information over time to a user and for determining whether the user is paying attention to said information. The invention has particular, although no exclusive, utility in relation to the presentation of advertising information over a network of computers, such as the Internet.

### BACKGROUND ART

The growing use of the Internet for commercial purposes has seen a corresponding increase in the use of this medium for advertising.

Initially, advertising took the form of graphical images embedded into an Internet page. Such images are commonly referred to as banners. Since these banners are embedded into the page, they can be lost from sight when the user scrolls the page. Accordingly, such banner advertising can have limited effect.

In an attempt to ensure that users will read the advertising, some Internet pages create separate displays in which advertising material is presented. This separate display generally appears in front of other information, forcing the user to read the advertising information. However, many users find this form of advertising irritating and tend to close the separate display, thereby removing the advertising information altogether.

More recently, reward or incentive-based advertising has become popular on the Internet, such as that offered by the company AllAdvantage. Such forms of advertising create a separate portion of the user's display that is dedicated to the presentation of advertising information. The user is credited for the volume of advertisements or time spent during which the advertising information is visible. Since the separate display portion does not obstruct the user's viewing of other Internet pages, this form of advertising can be less irritating to a user. However, there is no guarantee with this system that the user is watching any of the advertisements.

Current banner advertisement models have low responsiveness, with the proportion of users who indicate interest by clicking on the banner advertisement dropping to around 0.3%. Accordingly, many businesses are refraining from using the Internet as an advertising medium because of the perceived low effectiveness of the advertising medium. This has led to a perceived low monetary value of internet advertising to advertisers. These factors have led to a need for more effective Internet advertising methods that can convey a strong punchy message akin to television style advertising.

A number of companies are attempting to bring television-style advertising to the Internet with limited success, such as Unicast—www.unicast.com and KMGI—www.kmgi.com. These companies are struggling to find acceptance for their advertising methods because the internet, being an interactive medium, is not appropriate for interruptive advertising methods. Users are loath to be interrupted when they are surfing the Internet.

### DISCLOSURE OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

In accordance with a first aspect of this invention, there is provided a system for presenting information over time to a user, comprising:

processing means arranged to store presentation information and control information;

means, responsive to the presentation information and the control information, to produce a presentation which includes at least one prompt to the user at at least one point during the presentation;

a user appliance arranged to deliver the presentation over time to the user;

said user appliance arranged to communicate to the processing means whether the user provided a desired response within a predefined period during and/or after each prompt;

said processing means arranged to credit the user with having paid attention to the information upon being notified by the user appliance that the desired response was received within the predefined period.

Preferably, said prompt includes a visual icon, and said means responsive to the presentation information and the control information is arranged to overlay said icon on said information.

Preferably, said means responsive to the presentation information and the control information is arranged to randomly place the icon on said information.

Preferably, said control information includes zone information defining at least one first region where said icon can be placed, said means responsive to the presentation information and the control information arranged to randomly place said icon within one of said first regions.

Preferably, said control information includes zone information defining at least one second region where said icon can not be placed, said means responsive to the presentation information and the control information arranged to randomly place said icon in a position that is not within any of said second regions.

Preferably, the control information includes minimum delay information, said means responsive to the presentation information and the control information arranged to provide a delay between adjacent prompts that is not less that said minimum delay information.

Preferably, said control information includes a minimum and maximum presentation time for each prompt, said means responsive to the presentation information and the control information arranged to randomly determine a presentation time for each prompt according between said minimum and maximum presentation time.

Preferably, said predetermined period comprises the presentation time for each prompt.

Preferably, said processor means is arranged to dynamically generates at least a portion of said control information.

Preferably, said processor means is arranged to dynamically generates minimum and maximum presentation time for each prompt.

Preferably, said presentation is terminated if the user does not provide the desired response.

In one arrangement, said means responsive to the presentation information and the control information comprises the processing means.

In an alternative arrangement, said means responsive to the presentation information and the control information comprises the user appliance.

In accordance with a second aspect of this invention, there is provided a method for presenting information over time to a user, comprising the steps of:

presenting said information over time to the user;

providing a prompt to the user at at least one point during the presentation of said information;

determining whether the user provides a desired response within a predefined period during and/or after each prompt; and

crediting the user with having paid attention to the information only if the user provides all desired responses.

Preferably, said prompt includes a visual icon, and said step of providing a prompt comprises overlaying said icon on said information.

Preferably, said step of providing a prompt comprises randomly placing the icon on said information.

Preferably, said method further comprises the step of defining at least one first region where said icon can be placed, and said step of providing a prompt comprises randomly placing said icon within one of said first regions.

Preferably, said method further comprises the step of defining at least one second region where said icon can not be placed, and said step of providing a prompt comprises randomly placing said icon in a position that is not within any of said second regions.

Preferably, said method further comprises the step of provided a minimum delay between adjacent prompts.

Preferably, said method further comprises the step of providing a minimum and maximum presentation time for each prompt, and said step of providing a prompt comprises providing said prompt for a random time between said minimum and maximum presentation time.

Preferably, said predetermined period comprises the presentation time for each prompt.

Preferably, said method further comprises the step of terminating said presentation if the user does not provide the desired response.

Preferably, the information is sent to a computer over a computer network, the information being presented to the user by the computer.

Preferably, the desired response comprises the user pressing a key or button.

In accordance with a third aspect of this invention, there is provided a computer-readable media having computer software stored thereon, the computer software arranged, when executed in a computer to perform method steps for presenting information over time to a user, the method steps comprising:

presenting said information over time to the user;

providing a prompt to the user at at least one point during the presentation of said information;

determining whether the user provides a desired response within a predefined period during and/or after each prompt; and

crediting the user with having paid attention to the information only if the user provides all desired responses.

Preferably, said prompt includes a visual icon, and said step of providing a prompt comprises overlaying said icon on said information.

Preferably, said step of providing a prompt comprises randomly placing the icon on said information.

Preferably, said method steps further comprise the step of defining at least one first region where said icon can be placed, and said step of providing a prompt comprises randomly placing said icon within one of said first regions.

Preferably, said method steps further comprise the step of defining at least one second region where said icon can not be placed, and said step of providing a prompt comprises randomly placing said icon in a position that is not within any of said second regions.

Preferably, said method steps further comprise the step of provided a minimum delay between adjacent prompts.

Preferably, said method steps further comprise the step of providing a minimum and maximum presentation time for each prompt, and said step of providing a prompt comprises providing said prompt for a random time between said minimum and maximum presentation time.

Preferably, said predetermined period comprises the presentation time for each prompt.

Preferably, said method steps further comprise the step of terminating said presentation if the user does not provide the desired response.

Preferably, the desired response comprises the user pressing a key or button.

The invention allows a new method of advertising with ability to ensure that television-style advertisements have been viewed in their entirety. This allows for permission based advertising to be truly effective on the internet, on a large scale. Because advertisers are assured that their advertisements have been viewed in their entirety, users can “choose” to view long running, television-style advertisements, in return for valuable rewards in the form of information/services/goods.

### BEST MODE(S) FOR CARRYING OUT THE INVENTION

The embodiment will be described with reference to the presentation of advertisements to a user via computer network, such as the Internet. However, it should be appreciated that the invention may be utilised with other forms of information. Further, it would be readily appreciated that other means of delivering the advertisement to the user may also be used.

In the embodiment, a user's computer 10 is connected to the Internet 12 in known manner. A server 14 is also connected to the Internet 12. The server 14 includes a store 16 of advertisement information, user registration information including credits awarded to each user, and advertising frequency and scheduling information that is derived from payments and advertising contracts undertaken by advertisers.

Advertisement information is provided in the store 16 for each advertisement. The advertisement information comprises presentation information which is used to recreate the advertisement for presentation to a user, and control information which is used to determine whether the user paid attention to the advertisement during the presentation. In the embodiment, the control information is used to determine when prompts will be presented to the user during the presentation of the advertisement, and to determine whether the user provided a desired response within an allowable time. The prompt may be audible or visual in nature, or a combination of both. If the user does not provide the desired response within the allowable time, it is inferred that the user was not paying attention to the advertisement, and the user is not credited with having paid attention to the advertisement, as described in more detail below.

The advertisement defined by the advertisement information in the embodiment is preferably a television-style advertisement, in order to better retain the user's interest. By providing a defined start and stop time, the presentation is a short burst to the user, in return for which the user is expected to pay complete attention.

In the embodiment, the control information comprises:

Prompt media information that includes the audio and/or visual information regarding the prompt to be presented to the user;

A minimum and maximum number of times the prompt will be presented to the user during the presentation of the advertisement;

The minimum delay between the presentation of adjacent prompts;

The minimum and maximum period of time each prompt is presented to the user;

The desired response from the user;

Zone information defining the regions within which the prompt may be presented to the user. The zone information may be inclusive or exclusive. That is, the zone information may define regions where the prompt is allowed to be presented, or it may define regions in which the prompt may not be presented. This allows the advertiser a degree of flexibility by ensuring that the prompt will not interfere with the primary advertising information. In this regard, the zone information may also consist of times within the presentation of the advertisement that the prompt may or not be presented, and/or areas within a display where the prompt may or not be presented in the case of a visual prompt.

In alternative embodiments a subset of the above control information

It should be appreciated that some of the control information may be dynamically generated by the server 14 to prevent users from adapting to the prompts in advertisements. In particular, the minimum and maximum number of times the prompt will be presented to the user may be dynamically generated by the server 14 each time advertisement information is sent to a user's computer 10 within predefined ranges.

When a user wishes to view advertisements, they initiate an advertisement presentation using an appropriate commend to their computer 10, such as by clicking an icon or activating a menu command. The computer 10 then obtains the advertisement information for the advertisement from the server 14. In this regard, the server 14 distributes advertisement information to the user's computer 10 in accordance with scheduling information that is derived from payments and advertising contracts undertaken by advertisers. The advertisement information may be distributed to the user's computer 10 in advance and cached, or it may be provided on demand.

In alternative embodiments, the presentations may be commenced without the user initiating them.

The computer 10 presents the advertisement to the user according to the presentation information contained in the advertisement information received from the server 14. In the embodiment, the advertisement may include video and/or audio as well as static visual information. It is preferred that the advertisement occupies the entire display of the computer 10 for maximum effect.

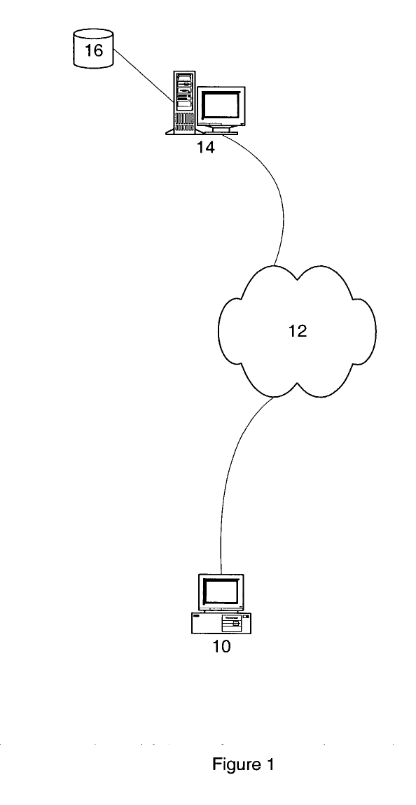

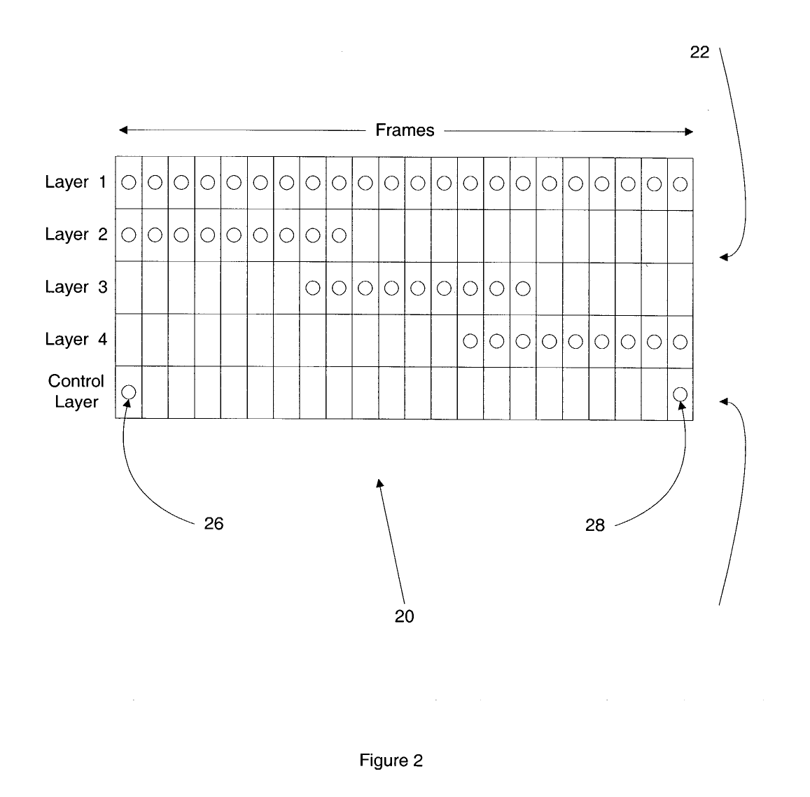

FIG. 2 shows an example of advertising information using Shockwave tool developed by Macromedia. The advertisement information comprises presentation information 22 and control information 24.

The presentation information 22 comprises four layers of information labelled layer 1 to layer 4. Each layer may relate to audio and/or visual information that is to be presented to the user at prescribed frames of the advertisement. In the example shown in FIG. 2, the frames correspond with the columns shown in the drawing.

Information in each layer for a particular frame is represented by a circle within each layer. Thus, it can be seen that layer 1 includes information for the entire advertisement, layer 2 includes information that will be presented simultaneously with layer 1 at the commencement of the presentation, layer 3 includes information that will be presented in the middle of the advertisement and which overlaps with information at the end of layer 2, and layer 4 includes information that would be presented at the end of the advertisement and which overlaps with layer 3.

The control information 24 consists of a single layer labelled control layer in FIG. 2. The control layer includes a control program 26 that is placed in the first frame of the advertisement information and a termination program 28 that is contained in the last frame of the advertisement information. Thus, when the advertisement is presented to the user, the control program 26 is executed at the commencement of the presentation.

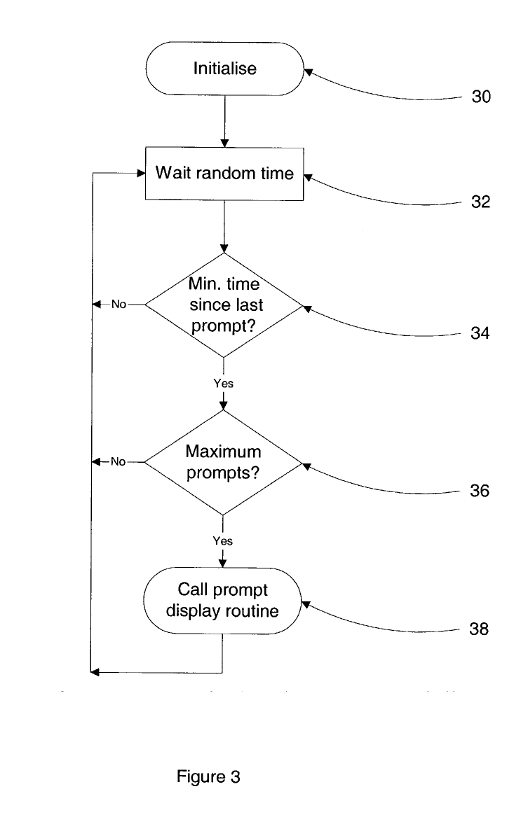

FIG. 3 is a flow chart showing the operation of the control program 26. The control program 26 firstly performs an initialisation at 30. This includes seeding a number generator that will be used to determine when prompts will be presented to the user. Also, the initialised routine 30 determines a probability for a prompt to be presented to the user at any given frame within the advertisement, having regard to the total number of frames within the advertisement, and the permissible times when prompts may be presented to the user defined by the zone information, and the minimum and maximum number of advertisements to be presented to the user.

Next, the control program 26 waits a random time at 32. This may be achieved in a number of ways, however in the embodiment it is achieved by assigning a probability that a prompt will be presented in each given frame, and determining during each frame whether to present prompt in accordance with that probability.

When the control program 26 determines that a prompt should be presented, a check is performed at 34 as to whether the minimum time has elapsed since the previous prompt was presented. If the minimum time has not elapsed, program control returns to the waiting routine at 32.

If the minimum time since the last prompt has elapsed, a check is then performed at 36 as to whether the maximum number of prompts has already been presented during the advertisement. If the maximum number of prompts has already been presented, program control returns to the wait function at 32, otherwise the prompt display routine is called at 38.

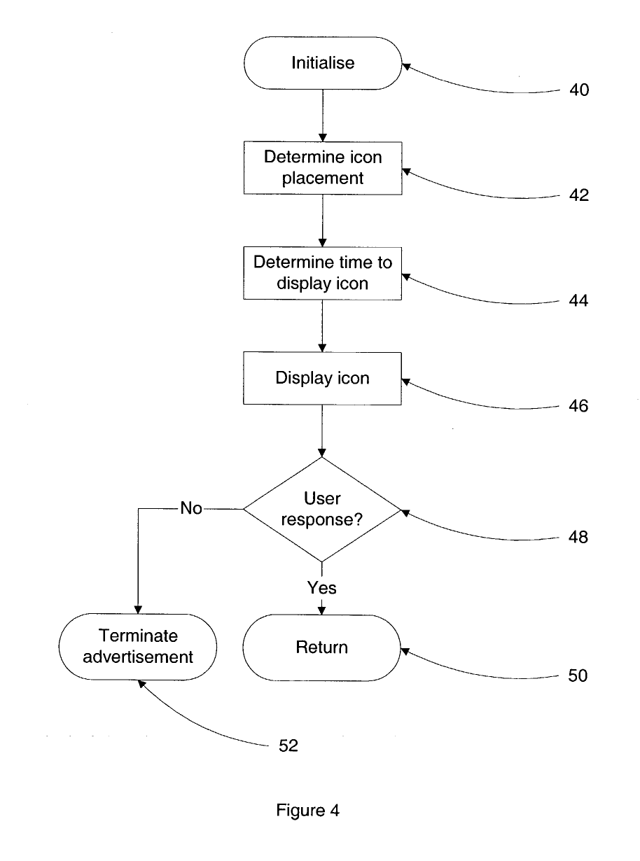

A flow chart of the prompt display routine is shown in FIG. 4, which commences with an initialised routine 40. Next, the prompt display routine determines the placement of the icon in the event that a visual prompt is used at 42. This is achieved by generating a random location for the position of the prompt having regard to any included or excluded zones contained in the zone information.

Next, the prompt display routine determines the period of time for which the prompt will be presented at 44 having regard to the minimum and maximum presentation times in the control information, following which the prompt is presented at 46.

The prompt display routine then determines whether a desired user's response was provided whilst the prompt was presented at 48. If the user provided a desired response, program control returns to the control program at 50, otherwise the presentation of the advertisement is terminated at step 52 and the user is informed that they did not comply with the requirements to be credited with having paid attention to the advertisement.

The nature of the desired response from the user can be any desired response, such as pressing a pre-defined key, clicking a mouse button or a more advanced responses such as clicking the mouse button with the cursor placed over the location of the prompt icon, or pressing a key which corresponds with the letter shown in the display icon on the screen. To assist the user in identifying the display icon, the display icon may be flashing or otherwise animated to attract the user's attention.

The prompt display routine will terminate the presentation of the advertisement if the user does not provide the desired response each time a prompt is presented to the user. Thus, the termination routine 28 contained in the last frame of the advertisement will only be executed with the user response to all prompts that are presented throughout the presentation of the advertisement. The termination routine 28 communicates with the server 14 to indicate that the user responded to all the prompts presented during the advertisement, in response to which the server 14 credits that user's information in the store 16 with having paid attention to the advertisement.

It is also envisaged that the user may respond to the advertisements he or she viewed and/or heard whilst paying attention to the advertisement presentation. Typically, such responses may include clicking a mouse button within the advertisement while pressing a pre-defined key to indicate that he or she desires further information concerning that advertisement. In the embodiment, it is preferred that the computer 10 continues to present the advertisement to the user and displays further information concerning the advertisement once the entire advertisement has presented to the user. In the embodiment, the control information may include an Internet URL relating to the advertisement, and the termination routine 28 will launch a web browser and direct it to the URL contained in the control information to provide the user with further information.

By crediting users with having paid attention to advertisements only if all prompts that are presented at random times and at locations throughout the advertisement are responded to, users are not able to obtain credit for paying attention to advertisements unless the user pays attention throughout the presentation of the advertisement. Thus, the embodiment provides a greater degree of security to advertisers that their advertisements are being observed. Randomly placing the prompt within the advertisement prevents a user from placing their cursor over the known location of the prompt and clicking their mouse button repeatedly while looking away in order to be falsely credited for paying attention to the entire advertisement. Presenting prompts at random times throughout the advertisement prevents the user from paying attention only when they know a prompt is about to be presented.

The embodiment has been described with reference to the presentation information and the control information being sent to the user's computer. However, in other embodiments, it may be desirable for the server 14 to process the presentation information and the control information. The server 14 would then present the resultant advertisement including any prompts to the user and would receive any responses from the user's computer or other appliance in order to determine whether a desired response was given. Such an embodiment would be ideally suited for situations where the appliance used by the user has limited functionality, such as a telephone. Thus, the server 14 may analyse the presentation information and the control information and deliver an audio advertisement containing audible prompts to the user and may analyse any tones generated by the user pressing keys on their telephone in order to determine whether a desired response has been provided.

Further, although the embodiment has been described with reference to the advertisement information being distributed by the server 14 via the Internet, it should be appreciated that in other embodiments, the advertising information may be embedded on a suitable media, such as a digital versatile disc (DVD).

Further, it is envisaged that the invention may be used with digital television, or any other user appliance capable of appropriate user interaction.

It should be appreciated that the scope of this invention is not limited to the particular embodiment described above.

1. A system for presenting information over time to a user, comprising:
processing means arranged to store presentation information and control information;
means, responsive to the presentation information and the control information, to produce a presentation which includes at least one prompt to the user at at least one point during the presentation;
a user appliance arranged to deliver the presentation over time to the user;
said user appliance arranged to communicate to the processing means whether the user provided a desired response within a predefined period during and/or after each prompt;
said processing means arranged to credit the user with having paid attention to the information upon being notified by the user appliance that the desired response was received within the predefined period.

2. The system of claim 1, wherein said prompt includes a visual icon, and said means responsive to the presentation information and the control information is arranged to overlay said icon on said presentation information.

3. The system of claim 2, wherein said means responsive to the presentation information and the control information is arranged to randomly place the icon on said presentation information.

4. The system of claim 2 or 3, wherein said control information includes zone information defining at least one first region where said icon can be placed, said means responsive to the presentation information and the control information arranged to randomly place said icon within one of said first regions.

5. The system of any one of claims 2 to 4, wherein said control information includes zone information defining at least one second region where said icon can not be placed, said means responsive to the presentation information and the control information arranged to randomly place said icon in a position that is not within any of said second regions.

6. The system of any one of claims 1 to 5, wherein the control information includes minimum delay information, said means responsive to the presentation information and the control information arranged to provide a delay between adjacent prompts that is not less that said minimum delay information.

7. The system of any one of claims 1 to 6, wherein said control information includes a minimum and maximum presentation time for each prompt, said means responsive to the presentation information and the control information arranged to randomly determine a presentation time for each prompt according between said minimum and maximum presentation time.

8. The system of claim 7, wherein said predetermined period comprises the presentation time for each prompt.

9. The system of any one of claims 1 to 8, wherein said processor means is arranged to dynamically generates at least a portion of said control information.

10. The system of claim 9, wherein said processor means is arranged to dynamically generates minimum and maximum presentation time for each prompt.

11. The system of any one of claims 1 to 10, wherein said presentation is terminated if the user does not provide the desired response.

12. The system of any one of claims 1 to 11, wherein said means responsive to the presentation information and the control information comprises the processing means.

13. The system of any one of claims 1 to 11, wherein said means responsive to the presentation information and the control information comprises the user appliance.

14. A method for presenting information over time to a user, comprising:
presenting said information over time to the user;
providing a prompt to the user at at least one point during the presentation of said information;
determining whether the user provides a desired response within a predefined period during and/or after each prompt; and
crediting the user with having paid attention to the information only if the user provides all desired responses.

15. The method of claim 14, wherein said prompt includes a visual icon, and said step of providing a prompt comprises overlaying said icon on said information.

16. The method of claim 15, wherein said step of providing a prompt comprises randomly placing the icon on said information.

17. The method of claim 15 or 16, further comprising the step of defining at least one first region where said icon can be placed, and said step of providing a prompt comprises randomly placing said icon within one of said first regions.

18. The method of any one of claims 15 to 17, further comprising the step of defining at least one second region where said icon can not be placed, and said step of providing a prompt comprises randomly placing said icon in a position that is not within any of said second regions.

19. The method of any one of claims 14 to 18, further comprises the step of provided a minimum delay between adjacent prompts.

20. The method of any one of claims 14 to 19, further comprising the step of providing a minimum and maximum presentation time for each prompt, and said step of providing a prompt comprises providing said prompt for a random time between said minimum and maximum presentation time.

21. The method of claim 20, wherein said predetermined period comprises the presentation time for each prompt.

22. The method of any one of claims 14 to 21, further comprising the step of terminating said presentation if the user does not provide the desired response.

23. The method of any one of claims 14 to 22, wherein the information is sent to a computer over a computer network, the information being presented to the user by the computer.

24. The method of claim 23, wherein the desired response comprises the user moving a cursor over an icon and pressing a button.

25. A computer-readable media having computer software stored thereon, the computer software arranged, when executed in a computer to perform method steps for presenting information over time to a user, the method steps comprising:
presenting said information over time to the user;
providing a prompt to the user at at least one point during the presentation of said information;
determining whether the user provides a desired response within a predefined period during and/or after each prompt; and
crediting the user with having paid attention to the information only if the user provides all desired responses.

26. The computer software of claim 25, wherein said prompt includes a visual icon, and said step of providing a prompt comprises overlaying said icon on said information.

27. The computer software of claim 26, wherein said step of providing a prompt comprises randomly placing the icon on said information.

28. The computer software of claim 26 or 27, wherein said method steps further comprise the step of defining at least one first region where said icon can be placed, and said step of providing a prompt comprises randomly placing said icon within one of said first regions.

29. The computer software of any one of claims 26 to 28, wherein said method steps further comprise the step of defining at least one second region where said icon can not be placed, and said step of providing a prompt comprises randomly placing said icon in a position that is not within any of said second regions.

30. The computer software of any one of claims 25 to 29, wherein said method steps further comprise the step of provided a minimum delay between adjacent prompts.

31. The computer software of any one of claims 25 to 30, wherein said method steps further comprise the step of providing a minimum and maximum presentation time for each prompt, and said step of providing a prompt comprises providing said prompt for a random time between said minimum and maximum presentation time.

32. The computer software of claim 31, wherein said predetermined period comprises the presentation time for each prompt.

33. The computer software of any one of claims 25 to 32, wherein said method steps further comprise the step of terminating said presentation if the user does not provide the desired response.

34. The computer software of and one of claims 25 to 33, wherein the desired response comprises the user moving a cursor over an icon and pressing a button.

35. A computer-implemented method for ensuring that a user pays attention to an advertisement, the method comprising the steps of:
receiving, at a user computer, presentation information and control information, the presentation information including the advertisement;
presenting the advertisement to the user at the user computer in accordance with the presentation information;
at the user computer and in accordance with the control information, outputting at least one prompt while the advertisement is presented to the user;
at the user computer, enabling the user to respond to the at least one prompt while the advertisement is presented to the user to signify that the user paid attention to the advertisement; and
communicating the response of the user to a remote server.

36. The method of claim 35 further comprising the steps of:
receiving the response of the user at the remote server; and
allocating a reward to the user if the response signifies that the user paid attention to the advertisement.

37. A system for recording whether a user pays attention to an advertisement, the user operating a user computer coupled to a communications network, the system comprising:
a server computer coupled to the communications network, the server computer storing presentation information and control information; and a computer program, operating upon the user computer, said computer program adapted to receive the presentation information and the control information from the server via the communications network and thereafter output the presentation information to the user via the user computer such that a prompt is output to the user in conjunction with the presentation information in accordance with the control information, said computer program adapted to receive a signal from the user in response to the prompt and thereafter communicate the signal via the communications network to the server computer.
